(19) United States
(12) Patent Application Publication
(10) Pub. No.: US 2006/0093365 A1
(43) Pub. Date: May 4, 2006

(54) Selectable host-transceiver interface protocol

(76) Inventors: Gerald L. Dybsetter, Scotts Valley, CA (US); Luke M. Ekkizogloy, San Jose, CA (US); Jayne C. Hahin, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/228,829

(22) Filed: Sep. 16, 2005

Related U.S. Application Data
(60) Provisional application No. 60/623,567, filed on Oct. 29, 2004.

(51) Int. Cl. H04B 10/00

(52) U.S. Cl. 398/135

(57) ABSTRACT

An optical transceiver, including a memory and a processor, which is capable of supporting different host interface protocols for communication between the optical transceiver and a host computing system. Each of the host interface protocols may be implemented by selecting microcode that corresponds to a particular host interface protocol and loading the microcode into the memory. The processor may later execute the microcode and cause the transceiver and the host to communicate using the specified interface protocol. The host interface protocols may also be implemented by hardware contained in the optical transceiver.

### CROSS-REFERENCE TO RELATED APPLICATIONS

This application claims the benefit of U.S. Provisional Application No. 60/623,567, filed Oct. 29, 2004, which is incorporated herein by reference in its entirety.

### BACKGROUND OF THE INVENTION

1. The Field of the Invention

The present invention relates generally to optical transmitters, receivers, and transceivers. More specifically, the present invention relates to optical transmitters, receivers and transceivers that have a selectable communication interface for communicating with a host computing system.

2. Background and Relevant Art

Computing and networking technology have transformed our world. As the amount of information communicated over networks has increased, high speed transmission has become ever more critical. Many high speed data transmission networks rely on optical transceivers and similar devices for facilitating transmission and reception of digital data embodied in the form of optical signals over optical fibers. Optical networks are thus found in a wide variety of high speed applications ranging from as modest as a small Local Area Network (LAN) to as grandiose as the backbone of the Internet.

Typically, data transmission in such networks is implemented by way of an optical transceiver that includes both a transmit path and a receive path. The transmit path includes an optical transmitter (also referred to as an electro-optic transducer), such as a laser or Light Emitting Diode (LED). The electro-optic transducer emits light when current is passed through it, the intensity of the emitted light being a function of the current magnitude. The receive path includes an optical receiver (also referred to as an optoelectronic transducer), an example of which is a photodiode. The optoelectronic transducer receives light and generates a current, the magnitude of the generated current being a function of the intensity of the received light.

The electro-optic transducer may be coupled to a host computing system. The host computing system may provide data to the optical transceiver for optical transmission, and may receive data from the optical transceiver that the optical transceiver in turn received from the optical receive channel. The host computing system may also receive alarms or warnings from the optical transceiver. The host computing system may perform other functions on the optical transceiver such as, for example, diagnostics.

Typically, a host computing system is configured to communicate with the optical transceiver using a single interface protocol. Different interface protocols may have unique advantages and disadvantages that make one protocol excellent for one purpose, but less efficient for other purposes. The host computing system may communicate with the optical transceiver for a number of different purposes. Accordingly, the single interface protocol may not be the most efficient interface protocol to use for all communications between the host computing system and the optical transceiver.

Therefore, what would be advantageous is a mechanism for communicating between a host computing system and an optical transceiver without being limited to a single interface protocol.

### BRIEF SUMMARY OF THE INVENTION

The foregoing problems with the prior state of the art are overcome by the principles of the present invention, which relate to an optical transceiver, including a memory and a processor, that is capable of supporting different host interface protocols for communication between the optical transceiver and a host computing system (hereinafter also referred to as the “host”). Each of the host interface protocols may be implemented by selecting microcode that corresponds to a particular host interface protocol and loading the microcode into the memory. The processor may later execute the microcode and cause the transceiver and the host to communicate using the specified interface protocol. The host interface protocols may also be implemented by hardware contained in the optical transceiver.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 schematically illustrates an example of an optical transceiver that may implement features of the present invention;

FIG. 2 schematically illustrates an example of a control module of FIG. 1;

FIG. 3 illustrates a flowchart of a method for selecting and implementing a particular host interface protocol in accordance with a first embodiment of the present invention;

FIG. 4 illustrates a flowchart of a method for selecting and implementing a particular host interface protocol in accordance with a second embodiment of the present invention;

FIG. 5 illustrates a flowchart of a method for selecting and implementing a particular host interface protocol in accordance with a third embodiment of the present invention; and

FIG. 6 illustrates a flowchart of a method for selecting and implementing a particular host interface protocol in accordance with a fourth embodiment of the present invention.

### DETAILED DESCRIPTION OF THE PREFERRED EMBODIMENTS

The principles of the present invention relate to an optical transceiver, including a memory and a processor, which is capable of supporting different host interface protocols for communication between the optical transceiver and a host computing system (hereinafter also referred to as the “host”). Each of the host interface protocols may be implemented by selecting microcode that corresponds to a particular host interface protocol and loading the microcode into the memory. The processor may later execute the microcode and cause the transceiver and the host to communicate using the specified interface protocol. The host interface protocols may also be implemented by hardware contained in the optical transceiver. An example operational optical transceiver environment will first be described. Then, the operation in accordance with the invention will be described with respect to the operational environment.

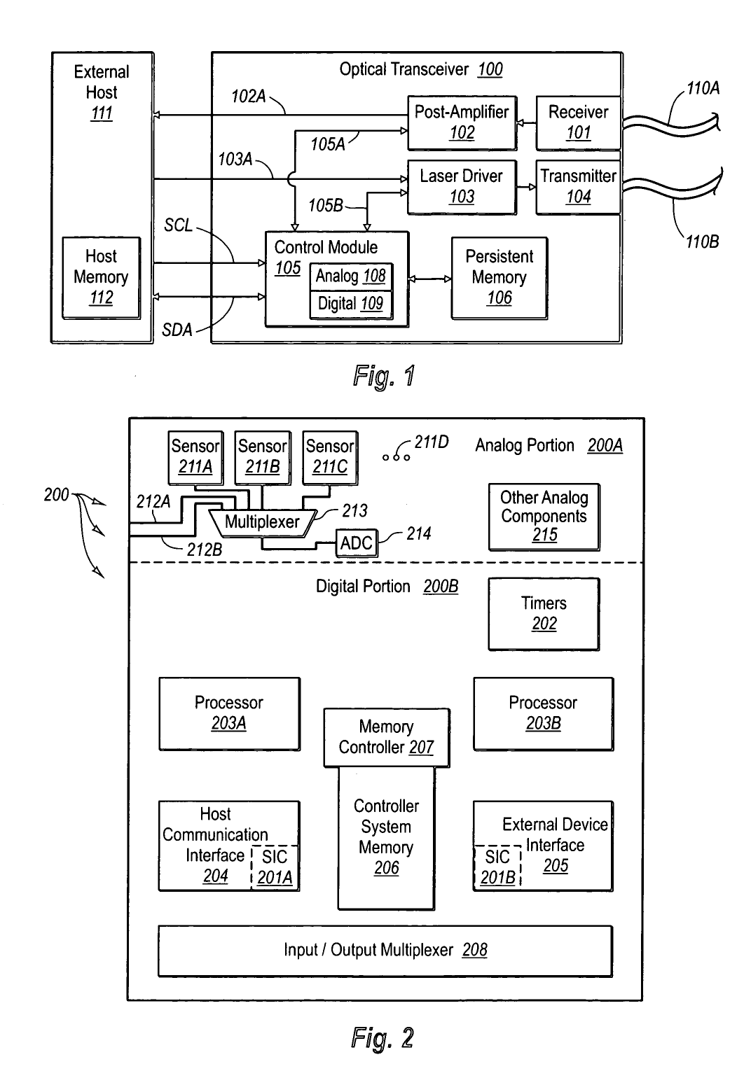

FIG. 1 illustrates an optical transceiver 100 in which the principles of the present invention may be employed. While the optical transceiver 100 will be described in some detail, the optical transceiver 100 is described by way of illustration only, and not by way of restricting the scope of the invention. The principles of the present invention are suitable for 1G, 2G, 4G, 8G, 10G and higher bandwidth fiber optic links. Furthermore, the principles of the present invention may be implemented in optical (e.g., laser) transmitter/receivers of any form factor such as XFP, SFP and SFF, without restriction. Having said this, the principles of the present invention are not limited to an optical transceiver environment at all.

The optical transceiver 100 receives an optical signal from fiber 110A using receiver 101. The receiver 101 acts as an opto-electric transducer by transforming the optical signal into an electrical signal. The receiver 101 provides the resulting electrical signal to a post-amplifier 102. The post-amplifier 102 amplifies the signal and provides the amplified signal to an external host 111 as represented by arrow 102A. The external host 111 may be any computing system capable of communicating with the optical transceiver 100. The external host 111 may contain a host memory 112 that may be a volatile or non-volatile memory source. In one embodiment, the optical transceiver 100 may be a printed circuit board or other components/chips within the host 111, although this is not required.

The optical transceiver 100 may also receive electrical signals from the host 111 for transmission onto the fiber 110B. Specifically, the laser driver 103 receives the electrical signal as represented by the arrow 103A, and drives the transmitter 104 (e.g., a laser or Light Emitting Diode (LED)) with signals that cause the transmitter 104 to emit onto the fiber 110B optical signals representative of the information in the electrical signal provided by the host 111. Accordingly, the transmitter 104 serves as an electro-optic transducer.

The behavior of the receiver 101, the post-amplifier 102, the laser driver 103, and the transmitter 104 may vary dynamically due to a number of factors. For example, temperature changes, power fluctuations, and feedback conditions may each affect the performance of these components. Accordingly, the optical transceiver 100 includes a control module 105, which may evaluate temperature and voltage conditions and other operational circumstances, and receive information from the post-amplifier 102 (as represented by arrow 105A) and from the laser driver 103 (as represented by arrow 105B). This allows the control module 105 to optimize the dynamically varying performance, and additionally detect when there is a loss of signal.

Specifically, the control module 105 may counteract these changes by adjusting settings on the post-amplifier 102 and/or the laser driver 103 as also represented by the arrows 105A and 105B. These settings adjustments are quite intermittent since they are only made when temperature or voltage or other low frequency changes so warrant. Receive power is an example of such a low frequency change.

The control module 105 may have access to a persistent memory 106, which in one embodiment, is an Electrically Erasable and Programmable Read Only Memory (EEPROM). The persistent memory 106 and the control module 105 may be packaged together in the same package or in different packages without restriction. Persistent memory 106 may also be any other non-volatile memory source.

The control module 105 includes both an analog portion 108 and a digital portion 109. Together, they allow the control module to implement logic digitally, while still largely interfacing with the rest of the optical transceiver 100 using analog signals. FIG. 2 schematically illustrates an example 200 of the control module 105 in further detail. The control module 200 includes an analog portion 200A that represents an example of the analog portion 108 of FIG. 1, and a digital portion 200B that represents an example of the digital portion 109 of FIG. 1.

For example, the analog portion 200A may contain digital to analog converters, analog to digital converters, high speed comparators (e.g., for event detection), voltage based reset generators, voltage regulators, voltage references, clock generator, and other analog components. For example, the analog portion 200A includes sensors 211A, 211B, 211C amongst potentially others as represented by the horizontal ellipses 211D. Each of these sensors may be responsible for measuring operational parameters that may be measured from the control module 200 such as, for example, supply voltage and transceiver temperature. The control module may also receive external analog or digital signals from other components within the optical transceiver that indicate other measured parameters such as, for example, laser bias current, transmit power, receive power, laser wavelength, laser temperature, and Thermo Electric Cooler (TEC) current. Two external lines 212A and 212B are illustrated for receiving such external analog signals although there may be many of such lines.

The internal sensors may generate analog signals that represent the measured values. In addition, the externally provided signals may also be analog signals. In this case, the analog signals are converted to digital signals so as to be available to the digital portion 200B of the control module 200 for further processing. Of course, each analog parameter value may have its own Analog to Digital Converter (ADC). However, to preserve chip space, each signal may be periodically sampled in a round robin fashion using a single ADC such as the illustrated ADC 214. In this case, each analog value may be provided to a multiplexer 213, which selects in a round robin fashion, one of the analog signals at a time for sampling by the ADC 214. Alternatively, multiplexer 213 may be programmed to allow any order of analog signals to be sampled by ADC 214.

As previously mentioned, the analog portion 200A of the control module 200 may also include other analog components 215 such as, for example, digital to analog converters, other analog to digital converters, high speed comparators (e.g., for event detection), voltage based reset generators, voltage regulators, voltage references, clock generator, and other analog components.

The digital portion 200B of the control module 200 may include a timer module 202 that provides various timing signals used by the digital portion 200B. Such timing signals may include, for example, programmable processor clock signals. The timer module 202 may also act as a watchdog timer.

Two general-purpose processors 203A and 203B are also included. The processors recognize instructions that follow a particular instruction set, and may perform normal general-purpose operation such as shifting, branching, adding, subtracting, multiplying, dividing, Boolean operations, comparison operations, and the like. In one embodiment, the general-purpose processors 203A and 203B are each a 16-bit processor and may be identically structured. The precise structure of the instruction set is not important to the principles of the present invention as the instruction set may be optimized around a particular hardware environment, and as the precise hardware environment is not important to the principles of the present invention.

A host communications interface 204 is used to communicate with the host 111, possibly implemented using a two-wire interface such as I²C shown in FIG. 1 as the serial data (SDA) and serial clock (SCL) lines on the optical transceiver 100. Other host communication interfaces may also be implemented as well. Data may be provided from the control module 105 to the host 111 using this host communications interface to allow for digital diagnostics and readings of temperature levels, transmit/receiver power levels, and the like. The external device interface 205 is used to communicate with, for example, other modules within the optical transceiver 100 such as, for example, the post-amplifier 102, the laser driver 103, or the persistent memory 106.

The internal controller system memory 206 (not to be confused with the external persistent memory 106) may be Random Access Memory (RAM) or non-volatile memory. The memory controller 207 shares access to the controller system memory 206 amongst each of the processors 203A and 203B and with the host communication interface 204 and the external device interface 205. In one embodiment, the host communication interface 204 includes a serial interface controller 201A, and the external device interface 205 includes a serial interface controller 201B. The two serial interface controllers 201A and 201B may communicate using a two-wire interface such as I²C or another interface so long as the interface is recognized by both communicating modules. One serial interface controller (e.g., serial interface controller 201B) is a master component, while the other serial interface controller (e.g., serial interface controller 201A) is a slave component.

An input/output multiplexer 208 multiplexes the various input/output pins of the control module 200 to the various components within the control module 200. This enables different components to dynamically assign pins in accordance with the then-existing operational circumstances of the control module 200. Accordingly, there may be more input/output nodes within the control module 200 than there are pins available on the control module 200, thereby reducing the footprint of the control module 200.

Having described a specific environment with respect to FIGS. 1 and 2, it will be understood that this specific environment is only one of countless architectures in which the principles of the present invention may be employed. As previously stated, the principles of the present invention are not intended to be limited to any particular environment. Accordingly, the principles of the present invention relate to an optical transceiver capable of implementing different host interface protocols. The host interface protocols are implemented by the selection of specific microcode relating to each host interface protocol. The principles of the present invention will be discussed with reference to the environment described in relation to FIGS. 1 and 2.

Conventional transceivers implement one specific host interface protocol. This host interface protocol was often times determined by the transceiver manufacturer. This was considered sufficient for conventional transceivers. However, if a user wanted to implement a different host interface protocol, it was often necessary to purchase a new transceiver module if implementing of a different host interface protocol was even possible.

The principles of the present invention make it possible to configure transceiver 100 in a way that allows transceiver 100 to potentially implement any desired host interface protocol. This is accomplished through the use of microcode (herein after also referred to as “interface microcode”) that is structured to implement different host interface protocols. A user selects an appropriate interface protocol, thereby causing the transceiver 100 execute the appropriate interface microcode so as to implement the desired host interface protocol. If a different host interface protocol is desired, then the user may simply select the new host interface protocol, thereby causing the transceiver 100 to execute the new interface microcode so as to implement the desired new host interface protocol. In this way, a single transceiver module may be able to support multiple host interface protocols. Additionally, the host transceiver protocol may be quickly changed as data rates, bandwidth needs, or other circumstances change.

There are many possible host interface protocols which may be implemented by transceiver 100. In the written description and in the claims, “host interface protocol” is defined as a format for transmitting clock and data signals between the host computing system and the transceiver. Some common host interface protocols that transceiver 100 may be configured by the interface microcode to support are I²C, Finisar Serial Bus (FSB), or other two wire interfaces, Universal Serial Bus (USB), serial interface, and parallel interface. FSB is a proprietary two wire interface, and is described in commonly-assigned co-pending U.S. patent application Ser. No. 10/814,024 filed Mar. 31, 2004, and incorporated herein by reference in its entirety. This list is not exhaustive and should not be read to limit the claims. It may be possible to configure transceiver 100 by microcode to support numerous other host interface protocols, whether now existing or whether not yet developed. FIG. 1 depicts an I²C interface being implemented by transceiver 100 as shown by the SDA and SCL lines. This is for illustration only. As mentioned, transceiver 100 may support numerous other host interface protocols.

The complexity of the microcode associated with implementing a specific host communication interface depends on the hardware available for supporting that interface. If, for example, the processor is to directly form the various communication frames associated with the protocol, rather than have a hardware component form the frames, then the microcode might be relatively complex. If, one the other hand, a specific hardware component (e.g., host communication interface 204) was available that merely needed to be activated (or appropriate configured) to implement the desired host interface protocol, the microcode may be relatively simple since only activation of the hardware component is needed. In one embodiment of the present invention, it may be possible to pre-load persistent memory 106 with a library of interface microcode sets for some or all possible host interface protocols.

In other embodiments of the present invention, the host interface protocol may be implemented by hardware within the optical transceiver 100. Referring to FIG. 2, host communication interface 204 contains interface controller 201A. In addition to the functionality already discussed, interface controller 201A can be configured to cause the host communication interface 204 to implement an identified host interface protocol. In some embodiments, the interface controller 201A receives microcode from the host 111 or another source that identifies which host interface protocol to implement. For example, if the host communication interface 204 were implementing an FSB protocol, the microcode would direct interface controller 201A to toggle an input/output pin of the host communication interface 204 that was configured to implement an I²C protocol. The toggling would cause the host communication interface 204 to begin to communicate with the host using the I²C protocol. The interface controller 201A could also cause the host communication interface 204 to change protocols by physically manipulating the host communication interface 204 in other ways besides toggling.

In other embodiments, the interface controller 201A can be a state machine that is configured to cause the host communication interface 204 to implement an identified host interface protocol. For example, the state machine may be in a state where it has configured the host communication interface 204 to communicate with the host 111 using the FSB protocol. The state machine can then change to a state where the state machine configures the host communication interface 204 to communicate with the host 111 using the I²C protocol by toggling an input/output pin of the host communication interface 204 that was configured to implement an I²C protocol. The state machine could also have states that caused the host communication interface 204 to implement the other host communication protocols previously discussed.

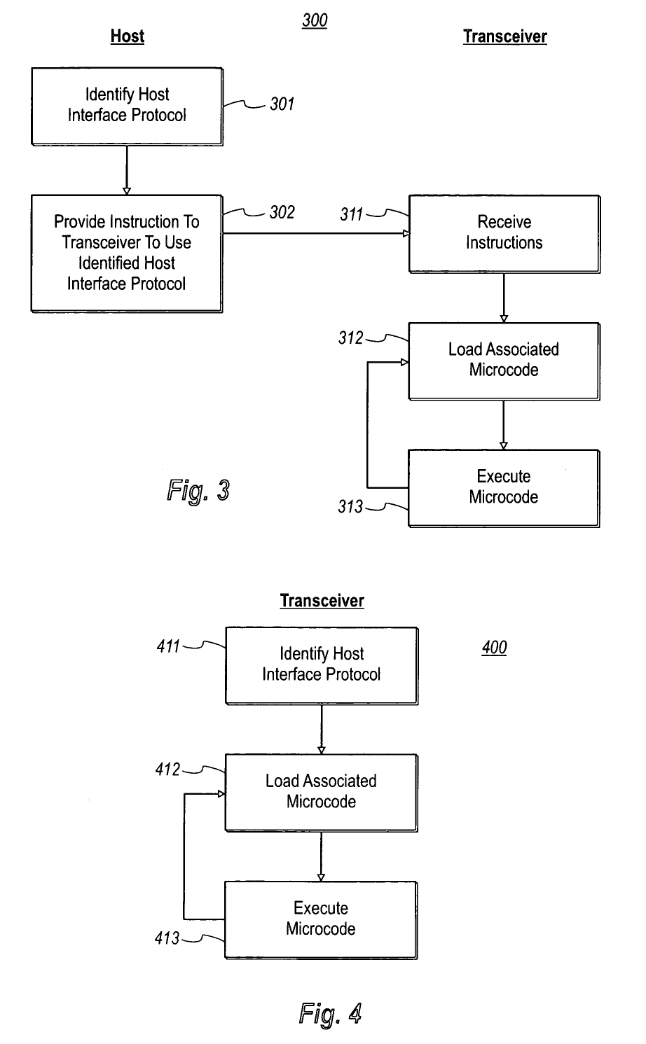

FIG. 3 illustrates a flowchart for a method 300 for selecting and implementing a host interface protocol for communication between a host computing system and an optical transceiver. The various acts illustrated in FIGS. 3, 4 and 5 may be performed by using a computer program product that includes one or more computer-readable media having thereon computer-executable instructions that, when executed by one or more processors, causes the host computing system to perform the various acts.

First, a particular host interface protocol is identified for use when communicating between the host computing system and the optical transceiver (act 301). For instance, a user may desire to implement a specific host interface protocol as circumstances dictate. Host 111 may be configured to allow the user to select the desired host interface protocol. Host 111 may have an attached keyboard or mouse that facilitates user interaction with the host. The user may use host 111 to access the control module 105. The host may also select the appropriate host interface protocol without user intervention. In any case, the host 111 directs that processors 203 load the appropriate interface microcode (act 302) from persistent memory 106 to controller system memory 206 for execution. In response to receiving this instruction (act 311), the transceiver loads the associated microcode from its memory (act 312) and executes the microcode (act 313) so that the optical transceiver operates to communicate using the selected host interface protocol.

For example, transceiver 100 may be implementing an FSB interface. However, it may be desirable to implement an I²C interface. The host 111 would then direct control module 105 (either on its own or in response to user direction) to load and execute the interface microcode for I²C. If control module 105 was a chip, then host communication 204 interface may be a number of dedicated pins. The I²C interface microcode, when executed, would cause transceiver 100 to configure the dedicated pins to support the I²C protocol. Mechanism for configuring pins with appropriate parameters is described in the commonly assigned co-pending U.S. patent application Ser. No. 10/970,530 filed Oct. 21, 2004. This would allow host 111 and transceiver 100 to communicate using the I²C protocol as shown in FIG. 1. In like manner, the user may implement the other host interface protocols.

FIG. 4 illustrates an alternative embodiment of a method 400 for selecting and implementing a desired host interface protocol. In this case, the transceiver itself identifies the appropriate host interface protocol (act 411). For instance, referring to FIG. 1, the control module 105 automatically implements the desired host interface protocol without instruction from the host by causing the processors 203 to load the appropriate interface microcode (act 412) and execute that microcode (act 413). For instance, the control module 105 may detect what interface hardware is used, and instruct the processors to load the appropriate microcode for the host interface protocol supported by that interface hardware.

For example, suppose that transceiver 100 was implementing an I²C host interface. Suppose further that it was desired to implement a serial host interface. A user may make a serial connection using, for example, a serial cable from host 111 to host communication interface 204, provided that host communication interface 204 is configured to handle the serial connection. Subsequently, the control module 105 determines that new interface hardware has been attached to host communication interface 204. Processors 203 may then load the serial interface microcode stored in persistent memory 106 to controller system memory 206 and execute the microcode. This may cause host communication interface 204 to support the serial host interface protocol and allow host 111 and transceiver 100 to communicate using the serial host interface protocol.

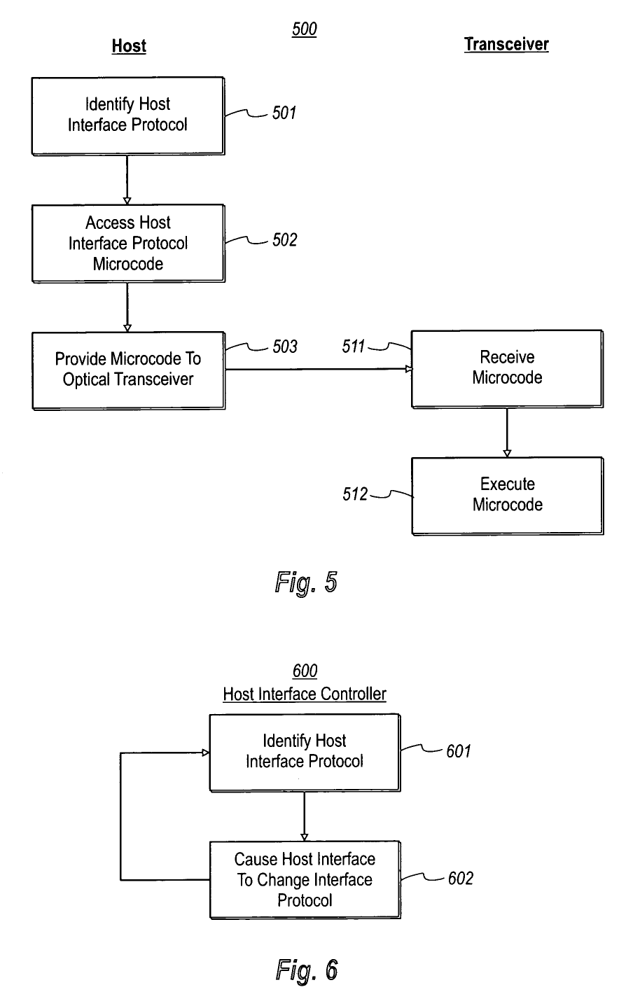

FIG. 5 illustrates a method 500 for selecting and implementing a desired host interface protocol in accordance with a third embodiment of the present invention. In this case, the host identifies the desired host interface protocol (act 501) either with or without user intervention, and then accesses the associated microcode for the selected host interface protocol (act 502). This may involve accessing the associated microcode over a network (e.g., from a remote data site), or perhaps from a local source (e.g., a Compact disk or hard drive).

For instances, the remote data site may be configured to allow a user to identify and select various desired host interface protocols through use of an interface such as a World Wide Web site. For example, the World Wide Web site may include a Web page that contains radio buttons that correspond to host interface protocols. A user may identify a desired host interface protocol by selecting the radio button for that feature using a keyboard or a mouse connected to host 111. This process may be repeated as appropriate for as many additional host interface protocols as desired.

The remote data site may be further configured to contain a library of interface microcode that corresponds to, and when executed implements, a specific host interface protocol. The remote data site may access the specific interface microcode corresponding to the host interface protocol identified by the selected radio button. The remote data site may then send the interface microcode to host 111 for further use.

In an alternative embodiment, persistent memory 106 may already be configured with a set of multiple interface microcodes. In that case, instead of downloading the selected interface microcodes, the host 111 selects the appropriate interface microcode to implement in accordance with the principles of the present invention.

Host 111 may then provide the interface microcode to the optical transceiver (act 503) using the currently implemented host interface protocol. Once received (act 511), the microcode may be stored in persistent memory 106 for later execution. Alternatively, the microcode may be directly loaded into controller system memory 206 for immediate execution (act 512). Once executed in the manner described previously, the interface microcode causes transceiver 100 to communicate with host 111 using the newly implemented host interface protocol.

FIG. 6 illustrates a method 600 for selecting and implementing a desired host interface protocol in accordance with a fourth embodiment of the present invention. In this case, an interface controller identifies the desired host interface protocol (act 601). For example, host interface controller 201A can identify the desired host interface protocol. For instance, in some embodiments, the host interface controller 201A receives microcode from the host or another source that causes the host interface controller to identify which interface protocol to implement. In other embodiments, the interface controller 201A is able to independently identify the interface protocol to implement. Interface controller 201A can be a state machine that identifies the protocol based on the state the state machine is in.

The interface controller causes the host interface to change the interface protocol (act 602). For example, the interface controller 201A can toggle an input/output pin of the host communication interface 204 that is configured to implement a particular interface protocol. For instance, if the host communication interface 204 were communicating with host 111 using the FSB protocol, the interface controller 201A could toggle pins that cause the host communication interface 204 to begin communicating with host 111 using the I²C protocol. At a later time, the interface controller 201A could, either in response to new microcode or in response to changing states, toggle pins that cause the host communication interface 204 to again begin communicating with host 111 using the FSB protocol.

Accordingly, the principles of the present invention provide for an optical transceiver with many benefits over current optical transceivers. Specifically, the present invention allows for easy selection and implementation of host interface protocols. A user has the ability to select a desired host interface protocol. Interface microcode that implements each selected host interface protocol may be loaded and executed by the transceiver, causing the transceiver to communicate with the host using the selected host protocol interface. This allows the user to control what host interface protocol the transceiver will implement. In addition, the user may repeat the process as necessary to change host interface protocols when circumstances dictate. Accordingly, the principles of the present invention represent a significant advancement in the art of optical transceivers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a host computing system that is communicatively coupled to an optical transceiver that includes a memory and at least one processor, a method for selecting and implementing a host interface protocol for communication between the host computing system and the optical transceiver, the method comprising the following:
an act of identifying a particular host interface protocol for use when communicating between the host computing system and the optical transceiver;
an act of obtaining microcode structured such that, when executed by the at least one processor of the optical transceiver, the optical transceiver is caused to use the, particular host interface protocol when communicating with the host computing system; and
an act of providing the obtained microcode to the optical transceiver.

2. A method in accordance with claim 1, further comprising:
subsequent to providing the obtained microcode to the optical transceiver, an act of communicating using the particular host interface protocol with the optical transceiver.

3. A method in accordance with claim 1, further comprising:
an act of the optical transceiver executing the provided microcode.

4. A method in accordance with claim 1, wherein the particular host interface protocol is a first host interface protocol, and the obtained microcode is first obtained microcode, the method further comprising the following:
an act of the host computing system communicating with the optical transceiver using the particular protocol after the act of the host computing system configuring the communication module and after the act of providing the first obtained microcode to the optical transceiver;
an act of identifying a second host interface protocol for use when communicating between the host computing system and the optical transceiver;
an act of obtaining second microcode structured such that, when executed by the at least one processor of the optical transceiver, the optical transceiver is caused to use the second host interface protocol when communicating with the host computing system; and
an act of providing the second obtained microcode to the optical transceiver.

5. A method in accordance with claim 1, further comprising the following subsequent to providing the second obtained microcode to the optical transceiver:
an act of communicating using the second host interface protocol with the optical transceiver.

6. In a network environment that includes a host computing system that is communicatively coupled to an optical transceiver that includes a memory and at least one processor, a method for selecting and implementing a host interface protocol for communication between the host computing system and the optical transceiver, the method comprising the following:
an act of identifying a particular host interface protocol to use when communicating between the host computing system and the optical transceiver; and
an act of the at least one processor of the optical transceiver executing microcode that is structured such that the execution causes the optical transceiver to communicate with the host computing system using the particular host interface protocol.

7. A method in accordance with claim 6, wherein the act of identifying a particular host interface protocol to use when communicating between the host computing system and the optical transceiver is performed by the optical transceiver without instruction from the host computing system.

8. A method in accordance with claim 6, wherein the act of identifying a particular host interface protocol to use when communicating between the host computing system and the optical transceiver is performed by the host computing system, the method further comprising the following:
act of the host computing system providing instructions to the optical transceiver to implement the particular host interface protocol.

9. A method in accordance with claim 8, wherein the host computing system performs the act of identifying a particular host interface protocol using user input.

10. A method in accordance with claim 8, wherein the host computing system performs the act of identifying a particular host interface protocol without user input.

11. A computer program product for use in a network environment that includes a host computing system that is communicatively coupled to an optical transceiver that includes a memory and at least one processor, the computer program product comprising one or more computer-readable media having thereon computer executable instructions that when, executed by the at least one processor of the optical transceiver, causes the optical transceiver to perform a method for selecting and implementing a host interface protocol for communication between the host computing system and the optical transceiver, the method comprising the following:
an act of identifying a particular host interface protocol to use when communicating between the host computing system and the optical transceiver;
an act of the at least one processor of the optical transceiver executing microcode that is structured such that the execution causes the optical transceiver to communicate with the host computing system using the particular host interface protocol.

12. A computer program product in accordance with claim 11, wherein the one or more computer-readable media are physical memory media.

13. In a network environment that includes a host computing system that is communicatively coupled to an optical transceiver that includes a host interface that is at least partially controlled by a host interface controller, a method for selecting and implementing a host interface protocol for communication between the host computing system and the optical transceiver, the method comprising the following:
an act of identifying a particular host interface protocol to use when communicating between the host computing system and the optical transceiver; and
an act of the host interface controller causing the host interface to implement the identified host interface protocol.

14. A method in accordance with claim 13, wherein the host interface controller causes the host interface to implement the identified host interface protocol by toggling an input/output pin of the host interface.

15. A method in accordance with claim 13, wherein the host interface controller is state machine.

16. A method in accordance with claim 15, wherein the state machine causes the host interface to implement the identified host interface when changing state.

17. A method in accordance with claim 13, wherein the host interface controller causes the host interface to implement the identified host interface protocol after receiving microcode.

18. A method in accordance with claim 13, wherein the host interface controller causes the host interface to implement the identified host interface protocol by physically manipulating the host interface.
